(19) United States
(12) Patent Application Publication
(10) Pub. No.: US 2024/0193676 A1
(43) Pub. Date: Jun. 13, 2024

(54) ADVANCED PLATFORM FOR HOSTING PHYSICAL AND VIRTUAL EVENTS

(71) Applicant: EBlock Corporation, Burlington, VT (US)

(72) Inventors: Boris Omar Echevers, Etobicoke (CA); Pavel Laktiushkin, Ajax (CA); Daniel Leroux, Kanata (CA); Jai Macker, Burlington, VT (US); Jason McClenahan, Navan (CA)

(21) Appl. No.: 18/534,940

(22) Filed: Dec. 11, 2023

Related U.S. Application Data
(60) Provisional application No. 63/386,681, filed on Dec. 9, 2022.

(51) Int. Cl. G06Q 30/08; G06Q 30/0601

(52) U.S. Cl. CPC G06Q 30/08; G06Q 30/0625

(57) ABSTRACT

An advanced event platform system and method are provided for generating a series of interfaces and controls applied across both physical and virtual events. The platform and associated method are accessible from a number of devices of varying configurations and adapted to provide a consistent user experience for operators hosting an event and event participants. The advanced platform system and method further provides consistent interaction and control of a plurality of available items spread over a plurality of lanes of an event, including the ability to modify descriptions for available items of an event or assign an available item across lanes or reassign an available item.

### CROSS-REFERENCE TO RELATED APPLICATIONS

This application claims priority to U.S. Provisional Application No. 63/386,681 filed on Dec. 9, 2022, the entire disclosure of which is incorporated herein by reference.

### TECHNICAL FIELD

The present teachings relate generally to events and, more particularly, to systems and methods for a uniform experience for hosting and participating in physical and virtual events using an advanced platform.

### BACKGROUND

Traditional events include the process of transferring items or services by providing a description, taking submissions, and then transferring the items or services to the user with the highest submission. However, in traditional events, only users who are physically present at the event site are able to participate and make submissions, etc.

Virtual (e.g., online, digital, remote) events are becoming more popular. In a virtual event, users register online and use technology to compete against other online users. Importantly, in virtual events, the users are remote from the event site.

Accordingly, traditional and virtual events each have unique needs and challenges. In particular, existing event hosting processes use different technologies and procedures, and are hosted as separate events-a participant either joins a physical event or joins a virtual event. As a result, the physical and virtual events provide inconsistent user experiences, such as “watch” and submission capabilities. Existing event processes also have inconsistent setup and control capabilities, which present problems for the event host or operator, which involves time and expense. Additionally, operators typically have to choose between hosting a virtual event or a physical event, or providing resources to host both separately.

Therefore, it would be beneficial to have an alternative system and method for a platform designed to accommodate both physical and virtual events in an advanced platform system providing a uniform experience for both operators and participants.

### SUMMARY

The needs set forth herein as well as further and other needs and advantages are addressed by the present embodiments, which illustrate solutions and advantages described below.

The present teachings relate to an advanced platform system for hosting physical and virtual events and a method for processing physical and virtual available items at the event(s) to provide a uniform participant experience.

One embodiment of a system according to the present teachings includes but is not limited to, a system for virtual and physical events involving multiple users having a computer system in communication with a datastore. The system also includes a plurality of events stored in the datastore, each event having a plurality of transfers, the plurality of transfers including a physical transfer and a virtual transfer, and each of the plurality of transfers having a plurality of available items. The computer system is adapted to provide a user interface to a computing device showing a lane for each of the plurality of available items. A physical lane may be associated with a physical available item in the physical transfer and a virtual lane may be associated with a virtual available item in the virtual transfer, which can be generated simultaneously on the user interface. The computer system is adapted to receive a submission through the user interface on the computing device for one of the plurality of available items.

In one embodiment, the user interface provides the same submission controls for either a physical available item or a virtual available item to provide a user a consistent experience.

In one embodiment, the computer system is adapted to provide an operator interface for configuring the plurality of events, the plurality of transfers associated with each event, the plurality of available items associated with each transfer, and a lane for each of the plurality of available items. The operator interface may provide the same configuration controls for configuring either the physical available item or the virtual available item so that a user has a consistent experience.

In one embodiment, the available items can be configured to move between the physical lane and the virtual lane.

In one embodiment, the advanced system can also include notifications that include both physical available items and virtual available items.

In one embodiment, the user interface comprises a webpage.

In one embodiment the computer system comprises processors communicating with each other over a network.

In one embodiment, the user interface comprises a selection of available events, and when a selected event is selected the user interface display a plurality of lanes for the selected event horizontally, and each of the associated plurality of available items for each lane are generated horizontally below the plurality of lanes.

In one embodiment, the computer system is adapted to provide remuneration information using a trained learning model, wherein the trained learning model is trained using starting remuneration, updated remuneration throughout the event, remuneration of similar items from past events, condition of the one of the plurality of available items, or a combination thereof.

One embodiment of a system according to the present teachings includes, but is not limited to, an advanced platform for hosting events with multiple users, having a computer system in communication with a datastore. The system also includes a plurality of events stored in the datastore, including virtual events and physical events, wherein each of the plurality of events having a plurality of available items, including virtual items and physical items. The computer system is adapted to provide an operator interface to a computing device, the operator interface showing a lane for each of the plurality of available items, such that a physical available item can be assigned to a physical lane and a virtual available item can be assigned to a virtual lane. The computer system is adapted to receive a selection through the operator interface on the computing device for adjusting an assignment for one of the plurality of available items and adjust the assignment for the one of the plurality of availability items based on the selection.

In one embodiment, the operator interface can be accessed via a mobile application, a webpage, or a combination thereof.

In one embodiment, the operator interface can include a lane identification for the lane for each of the plurality of available items.

In one embodiment, the operator interface can include an assigned number of the plurality of available items assigned to the lane.

In one embodiment, the computer system comprises processors communicating with each other over a network.

In one embodiment, the system includes a submission interface of the operator interface, wherein the computer system is adapted to receive user inputs associated with each of the plurality of available items.

In one embodiment, the user inputs can include an image, remuneration information, a location, an assigned lane, a declaration, a report, or a combination thereof.

In one embodiment, the user inputs are provided by an output of a trained learning model.

In one embodiment, the computer system is further adapted to extract information associated with the plurality of available items from the datastore and parse the information. The computer system is further adapted to identify a particular format of the plurality of available items, wherein the particular format includes a virtual format or a physical format based on whether the available item is a virtual item or a physical item. The computer system is adapted to assign each of the plurality of available items to one of the plurality of events and to a particular lane based on the particular format identified for the plurality of available items. The computer system is adapted to generate a lane identification and an assigned number on the operator interface for each of the plurality of available items and receive user inputs via a submission interface, wherein the user inputs are associated with one or more of the plurality of available items.

One embodiment of a method according to the present teachings includes, but is not limited to, an advanced method for hosting physical and virtual events with one or more participants, including: providing information related to a plurality of available items, including physical available items or virtual available items. The method also includes providing a computer system adapted to process the information related to the plurality of available items for one or more events. The method further includes identifying one or more parameters associated with the plurality of available items using the computing system, including whether an available item is a physical item or a virtual item. The method also includes assigning the plurality of available items to a plurality of lane of the one or more events, including either a physical lane or a virtual lane based on whether the available item is the physical item or the virtual item. The method further includes generating an operator interface to a computing device, the operator interface showing a lane for each of the plurality of available items. The method also includes receiving a selection through the operator interface using the computer system, wherein the selection includes adjusting an assignment for one of the plurality of available items and adjusting the assignment for the one of the plurality of availability items based on the selection.

In one embodiment, the method further includes receiving one or more submissions from the one or more participants using a submission interface of the computer system and processing the one or more submissions. The method also includes determining which submission is a higher value submission and generating a notification to a participant associated with the higher value submission using a notification interface of the computing system. The method further includes transmitting the notification to a computing device associated with the participant associated with the higher value submission.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a diagram of one embodiment of a system according to the present teachings.

FIG. 2 is an example user interface for the system of FIG. 1.

FIG. 3 is an example submission interface for an operator for the system of FIG. 1.

FIG. 4 is an additional example of a user interface provided in the form of a watchlist interface for the system of FIG. 1.

FIG. 5 is an additional example of an operator interface provided in the form of an active lanes overview interface for the system of FIG. 1.

FIG. 6 is an additional example operator interface provided in the form of an assigned item overview interface for the system of FIG. 1.

FIG. 7 is an additional example operator interface provided in the form of a lane selection interface for the system of FIG. 1.

FIG. 8. Is an additional example operator interface provided in the form of an available item order interface for the system of FIG. 1.

FIG. 9 is an example method of operation for the system of FIG. 1.

FIG. 10 is a method of operation for the system of FIG. 1.

FIG. 11 is an example method of operation and workflow for the system of FIG. 1.

FIG. 12 is an additional example user interface provided in the form of a notification interface for the system of FIG. 1.

FIG. 13 is an additional example operator and/or user interface provided in the form of an event information interface for the system of FIG. 1.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, it is noted that none of the appended claims or claim elements are intended to invoke 35 U.S.C. 112(f) unless the words “means for” or “step for” are explicitly used in the particular claim.

Events are used for the transfer of many different types of items and services. These include antiques, paintings, rare collectibles, expensive wines, commodities, livestock, radio spectrum, used cars, real estate, vacation packages, emission trading, and many more. It will be appreciated that when used throughout, “events” can include auctions, sales, transactions, deals, purchases, fairs, tradeshows, or other transfers of items and/or services. While the present teachings are discussed in the context of car events, the present teachings are not so limited and can be applied to events associated with any type of item or service.

In the context of car events, each event may run multiple “lanes” of vehicles. Drivers who work at the event bring cars through the lanes where the vehicle, the vendor, participants, and the paperwork on the vehicle all meet with an event operator. This meeting of documents and persons may be physical (e.g., “in person”), or may be conducted virtually using known forms of communication (e.g., through telephone, or fax). The event “operator” can include the host, event staff, or other personnel that coordinate to ensure that the right car is in the right place at the right time (e.g., moving through the correct lane).

A system according to the present teachings can host a single event (e.g., virtually broadcasted) with a combination of physical lanes and virtual lanes. This allows participants to, for example, attend a geography-oriented event that combines physical auto transfers and virtual auto transfers either physically (e.g., in person, onsite, etc.) or virtually (e.g., digitally, remotely, online, etc.). It will be appreciated that where used herein, “participant” can include a user, a purchaser, a bidder, or similar attendee of the event.

Such a system allows participants (e.g., wholesale automotive buyers) to control virtual and physical submissions in a single platform. It will be appreciated that where used herein, “submissions” can include bids, offers, requests or other attempt to obtain the one or more available items. The platform may include a process to allow participants to receive consistent notifications about item watches, both virtual and physical. For example, the participant can easily subscribe to individual available items regardless of whether it is being sold at a physical event or in a virtual event. The participant will receive consistent notifications in their method of choice (e.g., short message service (SMS), email, etc.) when these items are about to be available or otherwise go live at the event.

In one embodiment, a system according to the present teachings enables event participants to submit real-time submissions and automatic submissions in virtual and physical events in a single platform. The uniform platform improves the user experience by giving the participant a consistent interface regardless of whether they are participating physically or virtually. Event participants, for example, can set up “automatic submissions” (e.g., limit submissions) on available items they are interested in both before and during the event.

In addition, a system according to the present teachings enables operators to configure virtual and physical events in a single platform. For example, the platform provides a consistent experience for the operator making items available, scheduling the available items, and organizing the available items for the event. The operator can decide what available items are part of which “lanes”, without regard to whether they are physical or virtual items and/or whether it is a physical event or a virtual event.

In the context of the present teachings, an operator may create an event. Each event may have multiple lanes, which may be either physical or virtual. In addition, each lane may have multiple available items.

According to the present teachings, an operator can mix and match lanes from various physical or virtual events according to a particular parameter or feature (e.g., all classic cars, all convertibles, all red cars, all Fords, all sedans, etc.). According to the present teachings, physical and virtual available items may be combined in any number of different ways.

Similarly, participants can monitor and make submissions in multiple events simultaneously, without regard to whether they are physical or virtual events.

Combining physical and virtual events emphasizes the focus on user experience, which includes both operations and participants. The participant has the freedom to choose the way that makes sense to them, from the comfort of any location. The operator has the opportunity to maximize visibility of available items across physical and virtual spaces.

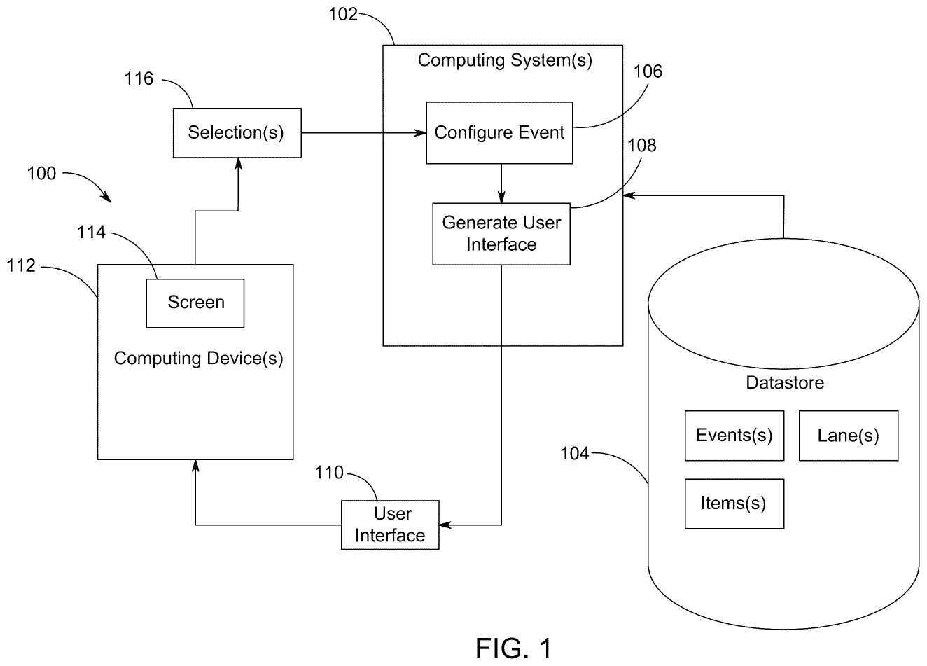

Referring to FIG. 1, shown is a diagram of one embodiment of a system 100 according to the present teachings.

As shown, one or more computers 102 (also generically referred to herein as a “computing system”) may provide functionality for the present teachings. The computer system 102 may include any number of computers and/or processors, which may communicate with each other over a network and rely on distributed computing resources. The computer system 102 may be provided in a form of one or more servers executing instructions stored on computer readable media to perform functionality according to the present teachings.

The computer system 102 may be in electronic communication with a datastore 104 that may store information on events, lanes, available items, user accounts, support information, user interfaces, etc., as will be appreciated by one skilled in the art.

The computer system 102 may include software executing on computer readable media that may be logically (but not necessarily physically) identified for particular functionality (e.g., functional modules). An event configurer 106 may receive information from the datastore 104 to configure, generate, or otherwise host an event. This may include a user interface generator 108 that generates a user interface 110.

The user interface 110 may be sent to a computing device 112 where a user can interact with the user interface 110 shown on a screen 114. The computing device 112 may be any type of computing machine, such as a desktop computer, tablet, mobile device, etc. In some embodiments, the computing device 112 may be physically present at the event (e.g., held by a user attending the event). In other embodiments, the computing device 112 may not be physically present at the event but is in communication with the computer system 102. Interactions with the user interface 110 may include, for example, submitting or otherwise participating in the event (e.g., watching) for participants, as well as setting up or otherwise configuring the event for the operator.

A user of the computing device 112 may make selections 116 as they interact with the user interface 110. Those selections 116 may be sent back to the computer system 102 where, for example, they may be used by the event configurer 106.

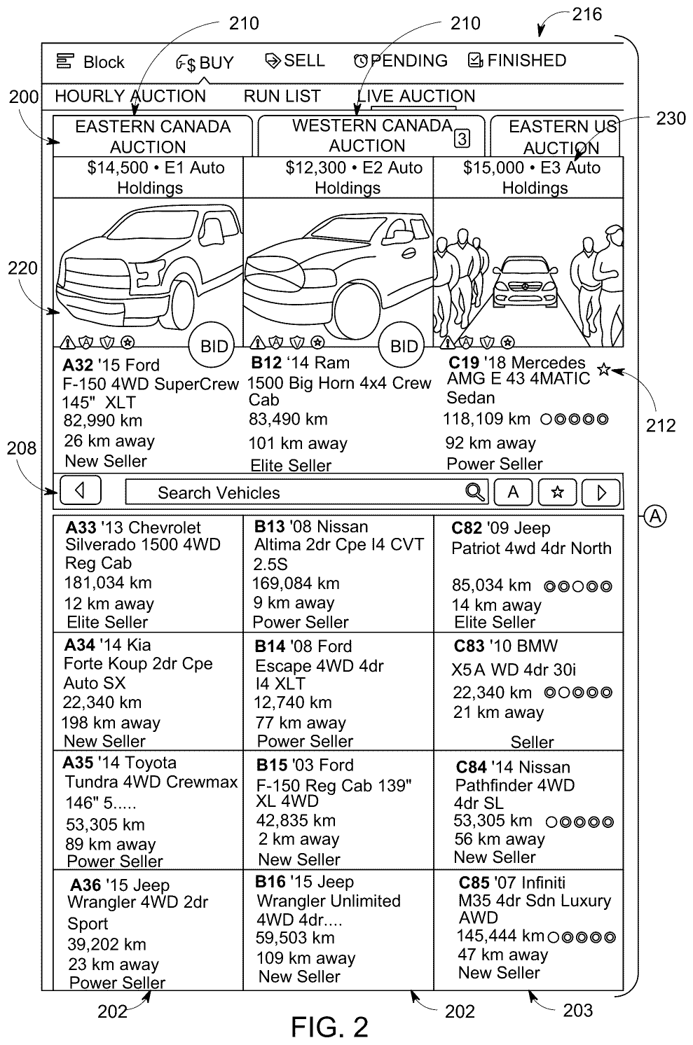

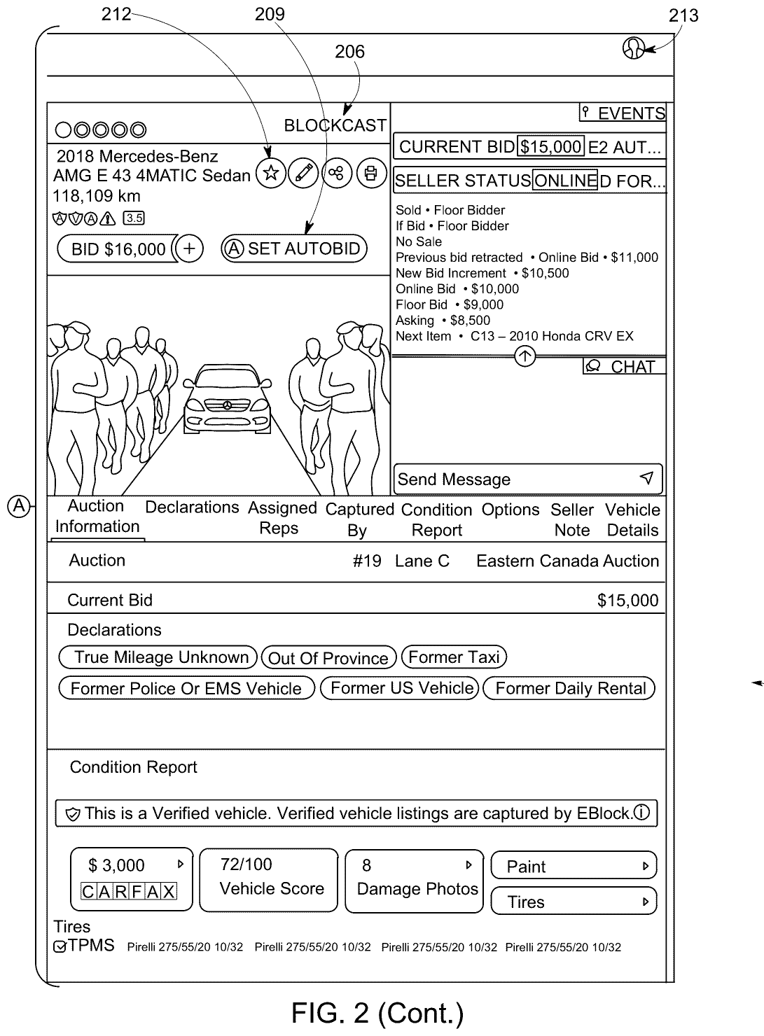

Referring to FIG. 2, shown is an example user interface 110 for the system of FIG. 1. The user interface 110 provides a single interest and notification platform for virtual and physical events. The interface further provides a single submission experience for virtual or physical available items. One or more events 200 may be selectable, shown here as available tabs 210.

An event 200 may have multiple lanes 202, 203. This may include both virtual lanes 202 as well as physical lanes 203. Each lane may have multiple available items, shown here as a sequential list of items coming up in both virtual lanes 202 and physical lanes 203. Available items that will be coming up as actively available may be sorted by time with a countdown displayed for the currently-available item and estimations shown for subsequent available items, or other methods described herein and known in the art. Each lane may also have a current item the event 200 is accepting submissions on, represented by virtual lane active item 220 and physical lane active item 230.

A search bar 208 may be present in the user interface 110, allowing a user to browse by keyword items in any virtual lane 202 or physical lane 203. An autosubmission feature 209 may be present in the user interface 110, allowing a user to engage in a series of automatically executed submissions in increments set by the user or the event up to or including a maximum amount for the specified item. A user may further select a favorite status 212 that assigns or marks a certain item to a watchlist, allowing the user to later view such selected items (e.g., in list format exclusive of other items at the event). Such a watchlist may be inclusive of all favorite status 212 items, or may be split into various categories, for example items in virtual lanes 202 or physical lanes 203.

Additionally or alternatively, items with favorite status 212 may display a star icon (or otherwise indicate on the user interface) when these items are displayed in the virtual lanes 202 or physical lanes 203. A user may further make a selection through the user interface 110 of the computing device 112 among any item in the virtual lanes 202 or physical lanes 203, including among the active items 220 and 230, with the resulting selection being displayed as item of interest 206. The item of interest 206 may be visible on the computing device 112, and include additional information such as real-time and historical submission information 205, which will indicate the opening or asking submissions, submission increments, the location (e.g., physically present on the floor, not physically present or online) of the participant submitting, and to whom the item was transferred or not transferred (e.g., when there is a reserve value for the item that was not met).

The item of interest 206 display may further duplicate features from the event interface 216, such as the autosubmission feature 209. The item of interest 206 interface may also include relevant information regarding the item, for example, third-party or operator-provided information concerning the condition of the item (e.g., vehicle mileage, crash history), additional photos of the item, declarations by the vendor of the item, estimated value of the item, options or features, and the event staff and/or operator assigned to the item. The item of interest 206 display may also include a communication interface 207 adapted to allow a user to communicate with the event (e.g. the operator, other participants, and vendors). In some embodiments, the communication interface 207 can be provided in the form of a chat box. In some forms, the communication interface 207 can include communication with an automated event assistant and/or platform virtual assistant (e.g., AI-based communication).

Both the participants and the operator users have a consistent experience for both physical and virtual events. A user can log in to the platform using an authentication module 213, which can determine access level(s) and user interface details. The user, once authenticated, can select an event 200 they want to participate in. The participant can use a single screen to view the interface with items available in both the virtual lanes 202 and the physical lanes 203 that are part of the event 200. In this way, the participant can use a single interface to view the combined run list (available items) for both the virtual and physical portions of the event.

The participant can virtually “visit” or otherwise select an individual lane to view the available items, regardless of whether the items are in a physical lane 203 or a virtual lane 202. The user can submit a submission on the active physical item 230 or active virtual item 220 using the same user interface and options. The participant can add submissions to any available item using the user interface, providing the user a consistent user experience. The participant will also be notified of winning submissions in a consistent way.

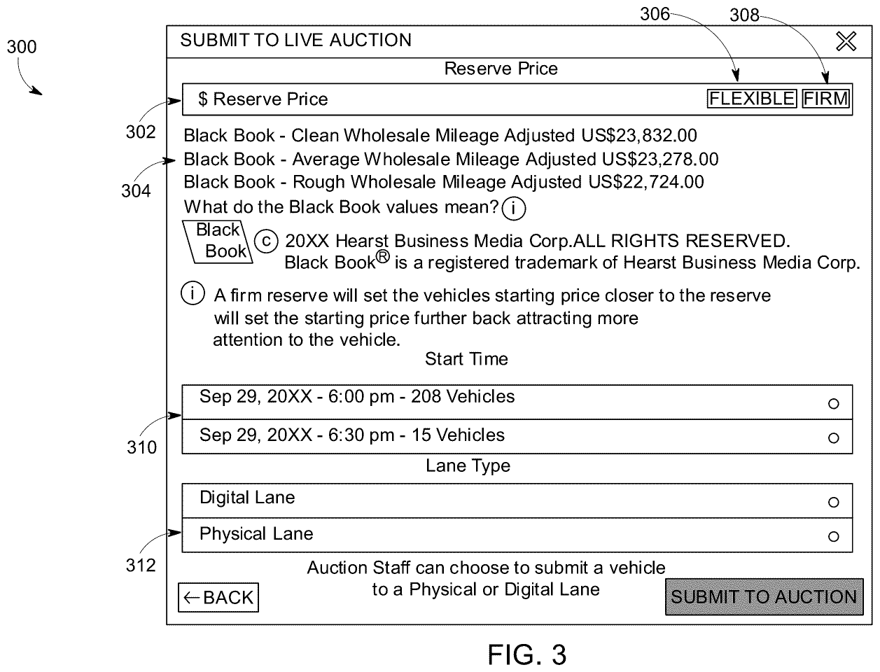

Referring now to FIG. 3, shown is an example user interface 110 provided in the form of a submission interface 300 for use by the operator when adding an item to an event 200. The user interface 110 provides a single administrative user experience for assigning available items to lanes. The submission interface 300 may allow the event staff to set a reserve value for the item (e.g. a minimum value in order for the item to be transferred) using a reserve value input 304, an event detail input 310 for the user to select a date and/or time for which the item may be actively available or alternatively select from a number of existing events 200 in which the item will be available. The submission interface 300 can also include a lane selection input 312 for the user to select the type of lane the item will be offered in (e.g., a physical lane 203 or a virtual lane 202).

The submission interface 300 may further feature information about the item transmitted, retrieved, or otherwise received from the datastore 104 of the computer system 202, or other database. For example, the submission interface 300 can include recommended remuneration 302, which can be based on a number of data elements, including but not limited to an average or recent closing remuneration of similar items, the estimated value of the item as provided by a third-party or the operator, or a combination thereof. It will be appreciated that where used herein, “remuneration” can include price, cost, rate, value, or similar. The submission interface 300 can include a reserve value input 304, further defined as either a flexible reserve value 306 or a firm reserve value 308, wherein the operator staff can select either “flexible” 306 or “firm” 308 as an input selection to the submission interface 300. In this example, a firm reserve value 308 will set the item starting submission value closer to the reserve value, whereas a flexible reserve value 306 will set the starting submission value to a lower value to attract more attention or submissions on the item. In some embodiments, the submission interface 300 The submission interface 300 can also include event details and/or start times about a specific event 200. The submission interface 300 may also include a Save button (not shown) to save the inputted item information for access at a later time and a Back button 314 to return to the previous screen. In some embodiments, the submission interface 300 may prompt the user to save any input information on the current screen before going to the previous screen, in the event the Back button 314 is selected. The submission interface can also include a Submit button 316, which uploads the item to the event 200. It will be appreciated that the submission interface 300 can also include other settings and selections other than those shown in FIG. 3 for the operator to submit an available item for the event.

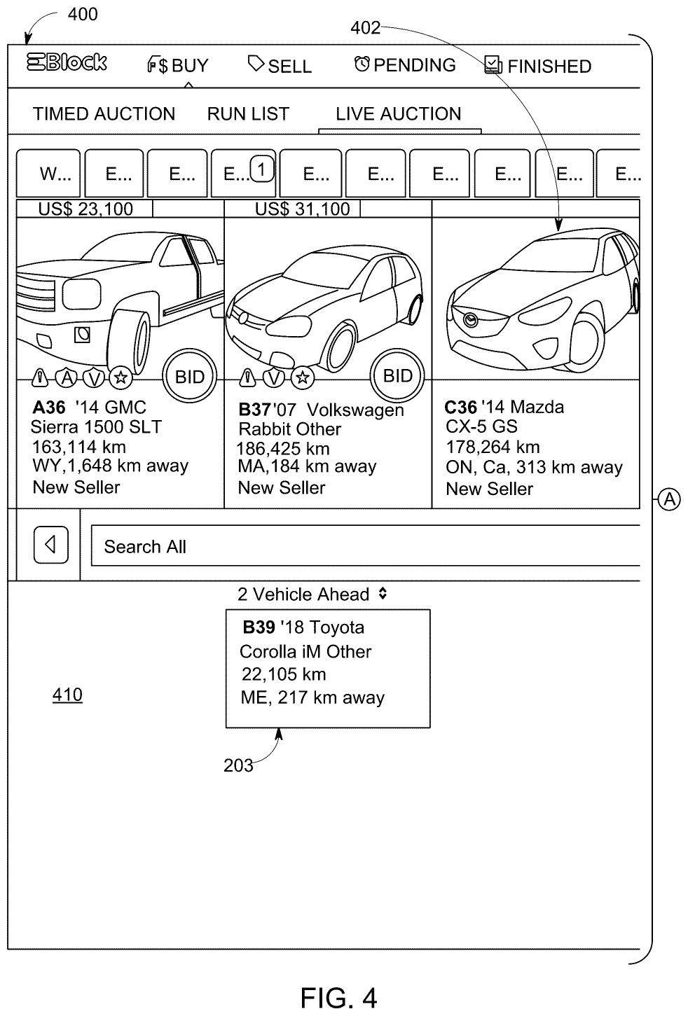

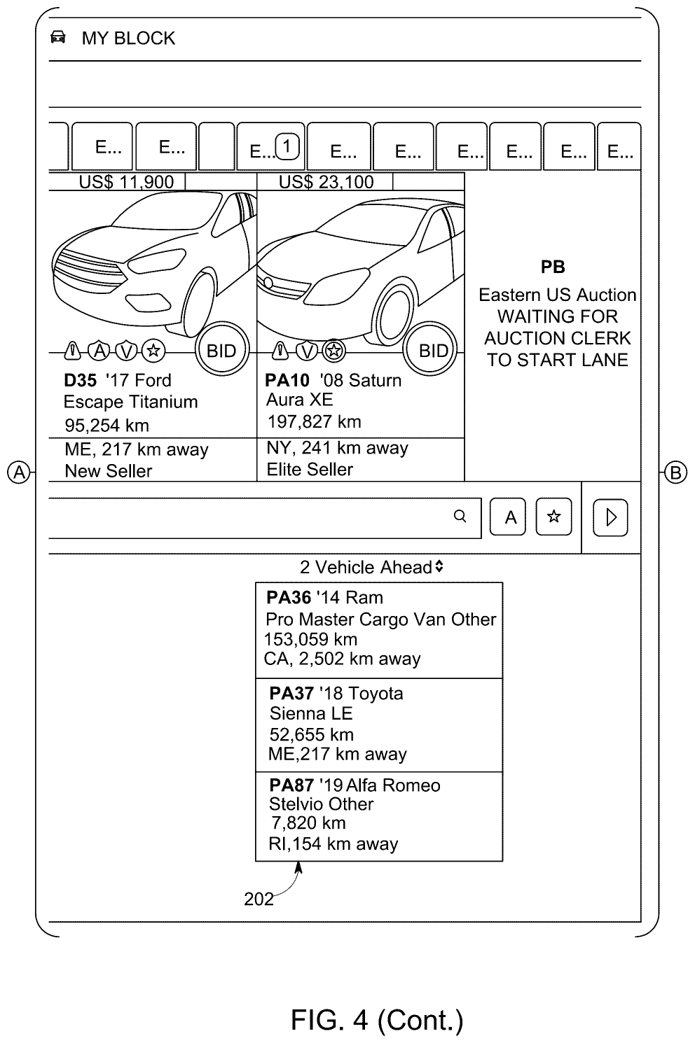

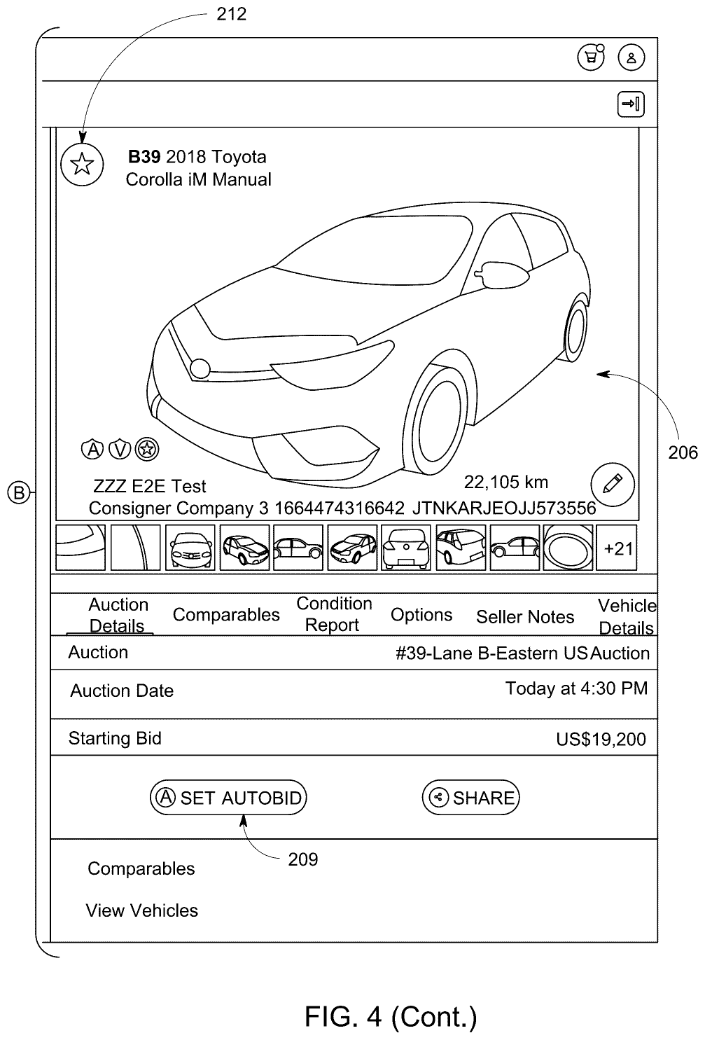

Referring now to FIG. 4, shown is an example user interface 110 provided in the form of a watchlist interface 400 for a selected event 200. The watchlist interface 400 may display a select group of items in a user watchlist 410. The watchlist interface 400 may further display a select group of items which a user has placed a submission upon 402, in conjunction with or separately from items in a user watchlist 410. The items in the watchlist 410 may be arranged into physical lanes 203 and virtual lanes 202. The watchlist interface 400 may further display items in a user watchlist 410 as highlighted in a particular color, representing the order the items may appear as active items 220 and 230 (see FIG. 2).

The watchlist 400 may further display items in a user watchlist 410 as highlighted in a particular color while other items in a related lane are displayed in a different color or in no color at all (e.g., “blank space”). In some embodiments, the user can modify the color a particular item is highlighted and/or hide certain items from view. The user can also quickly add and remove items from the watchlist 410 by selecting and deselecting the favorite status 212 (or similar icon or other input). The watchlist interface 400 may include other features discussed herein, including but not limited to the item of interest 206 display or autosubmission feature 209.

The participant can virtually visit or select an individual lane, whether a physical lane 203 or virtual lane 202, and can submit a submission on the live item 220 or 230 using the same user interface and selection options. The participant can add submissions to any available item using a consistent user experience. The participant will be notified of winning submissions in a consistent way.

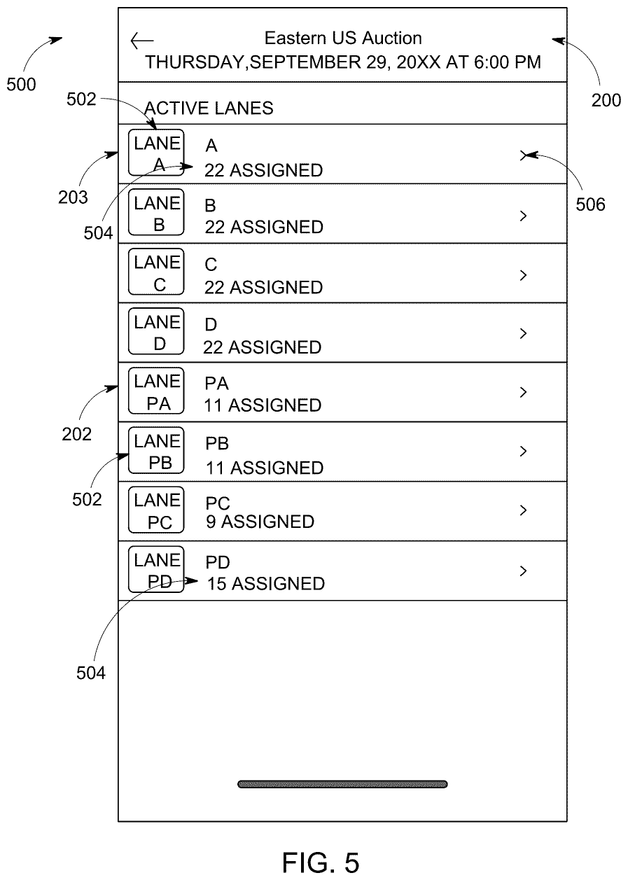

Referring now to FIG. 5, shown is an example user interface 110 provided in the form of an active lanes overview interface 500 for a selected event 200. The active lanes overview interface 500 provides the operator and/or other users an overview of active (e.g., in a current event) physical lanes 203 and virtual lanes 202. The active lanes overview interface 500 can also include the lane name 502 or other identification sequence of a given lane, and the number of items assigned 504 to a lane. A user or operator may further view additional information regarding a given lane through the arrow 506. The arrow 506 may open an additional user interface 110 discussed herein (e.g., the submission interface 300, the event interface 216, or other interfaces, features, options, or similar). It will be appreciated that the active lanes overview interface 500 shown in FIG. 5 is a non-limiting example and other configurations are contemplated.

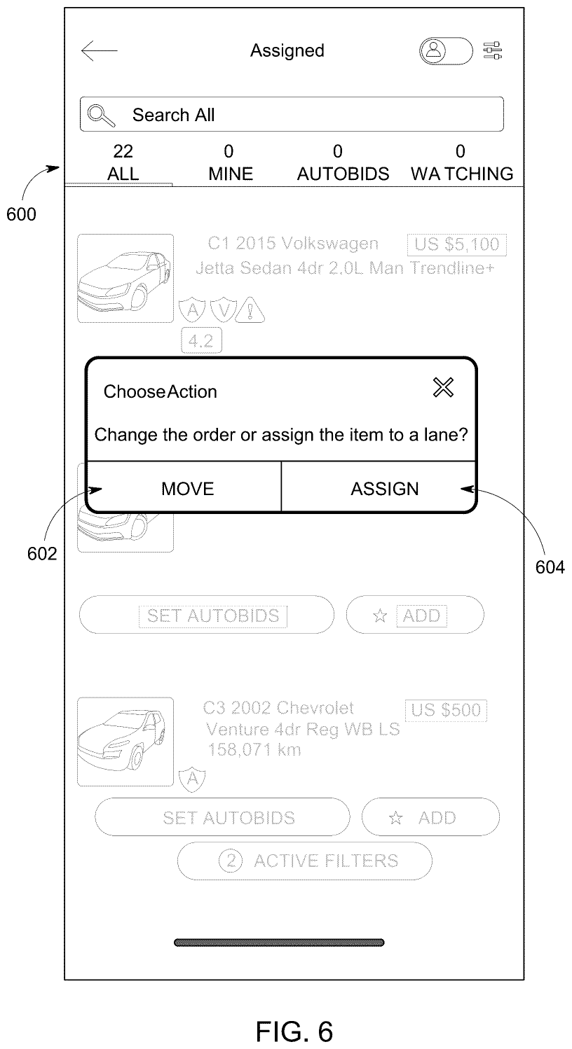

Referring now to FIG. 6, shown is an example user interface 110 for an operator provided in the form of an assigned item overview interface 600 for a selected event 200. An operator can control the event experience by submitting available items to an event. In some embodiments, the operator can submit available items using the submission interface, described in connection with FIG. 3. The operator or other user can also move available items between the physical lanes 203 and the virtual lanes 202. The active lanes overview interface 500 may lead to the assigned item overview interface 600 by selection of the arrow 506. A user and/or operator may be able to select a specific item from among the available items in a physical lane 203 or a virtual lane 202 and change the order in which the item will arise in an event 200 using a Move button 602. The operator can also assign the item to a different physical lane 203 or virtual lane 202, and/or reclassify the item as belonging to the physical lane 203 or the virtual lane 202 using an Assign button 604. In other examples, the item may be assigned to a different event 200. It will be appreciated that FIG. 6 is a non-limiting example and the assigned item overview interface 600 can be provided in different configurations than that shown in FIG. 6.

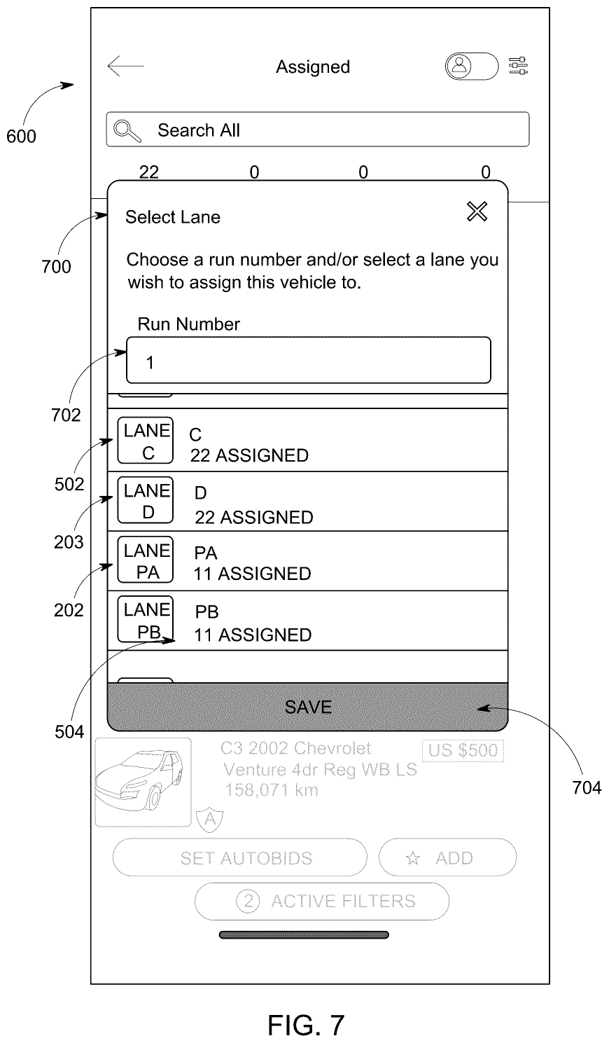

Referring now to FIG. 7, shown is an example user interface 110 with an alternative or additional embodiment to the assigned item overview interface 600 exemplified in FIG. 6. The user interface 110 shown in FIG. 7 can be provided in the form of a lane selection interface 700 for an operator for a selected event 200. The operator may select a particular physical lane 203 or virtual lane 202 in which to place an available item. The lane selection interface 700 may further provide a run input 702 box for a user to edit the run number. The run number can be assigned by the operator to control which lane and/or sequence the item will be available in the event. The lane selection interface 700 can further include information concerning the particular physical lane 203 or virtual lane 202, such as the lane identification number 502 or letter(s) associated with the particular lane, the number of items currently assigned to the particular lane 504, and other features discussed herein. The operator can select the Save button 704 to save the inputs provided in the selection interface 700 and push the updates to the event 200. It will be appreciated that FIG. 7 is a non-limiting example and the selection interface 700 can be provided in different configurations than that shown in FIG. 7.

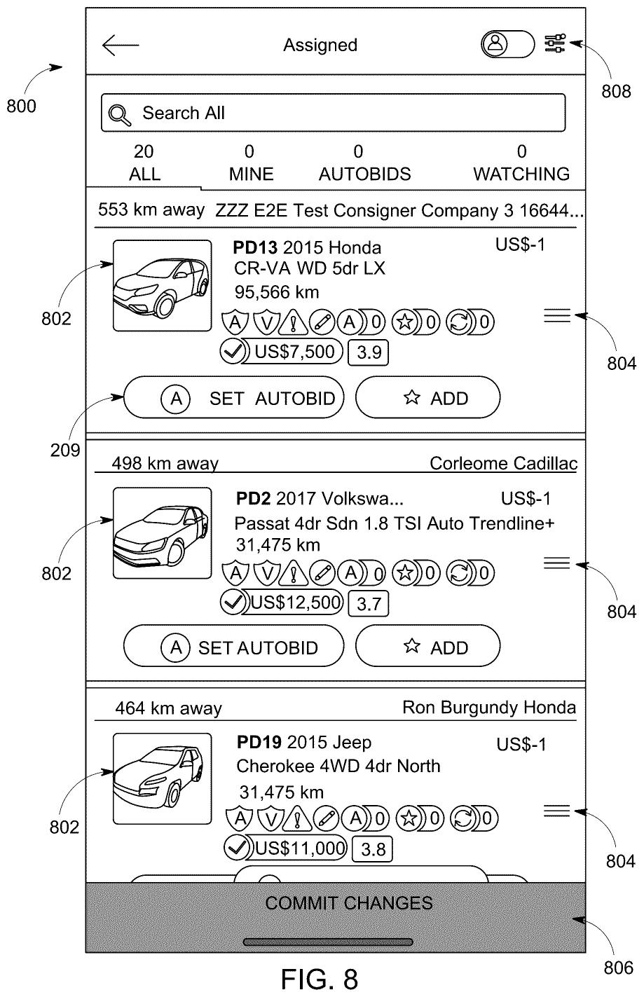

Referring now to FIG. 8, shown is an example user interface 110 with an alternative or additional embodiment to the assigned item overview interface 600 shown in FIG. 6. The user interface 110 shown in FIG. 8 can be provided in the form of an available item order interface 800 for an operator for a selected event 200. The available item order interface 800 is presented to an operator with a summary of the information associated with the related items within a particular physical lane 203 or virtual lane 202. An operator may be able to “scroll” or perform a similar action to view items above and below the available items 802 visible at any given time on the available item order interface 800. The operator can select and “drag” the items using the icon 804 to reorder the available items 802. The user can save adjustments to the order of the available items by selecting the Commit Changes button 806, or similar save button.

Available items 802 in the selected particular lane may be presented in ascending or descending order according to one or more parameters. The available item order interface 800 (or any other interface described herein) can include a filter option 808 designed to allow a user to select the one or more parameters. In some embodiments, the one or more parameters can include remuneration, time until the available item(s) will accept submissions, favorites and/or watchlist items, item characteristics (e.g., year, condition, color, etc.), physical order of items in a particular lane, or a combination thereof. It will be appreciated that other arrangements and configurations are contemplated.

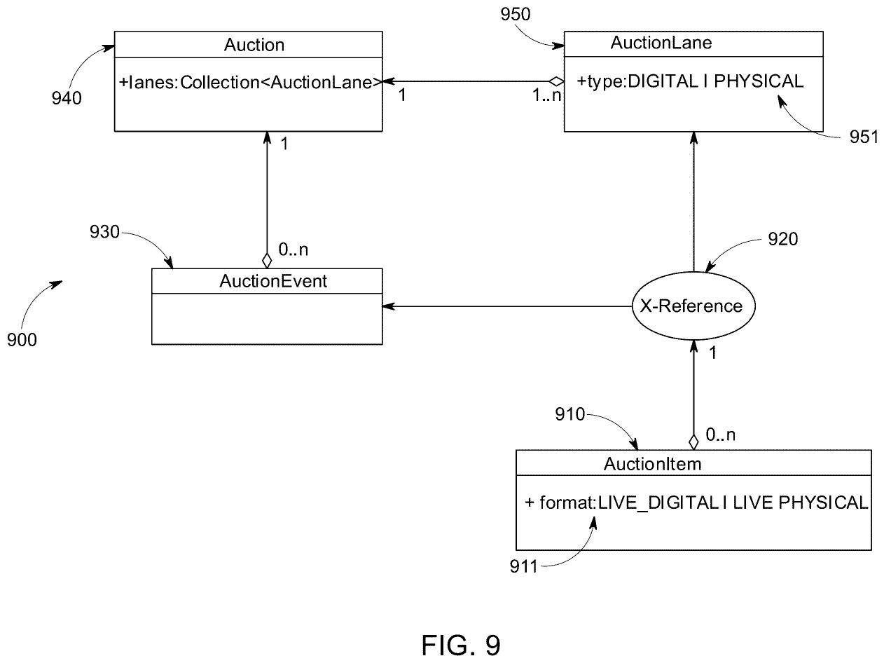

Referring now to FIG. 9, shown is an example method of operation 900 for the system of FIG. 1. An available item 910 is selected, and a particular format 911 is applied to the available item 910. The particular format is either a virtual format or a physical format, based on whether the available item is a virtual available item or a physical available item. The available item 910 is parsed or otherwise processed by reference 920 and assigned to a corresponding event 930. The system can extract the lane information 940 for a particular event and assign a specific lane 950. The assignment can include a lane type 951 (e.g., either a physical lane or a virtual lane based on whether the available item is a physical available item or a virtual available item). The assignment can also include a specific lane identifier (as described in more detail in connection with FIG. 5). The assigned lane type 951 and format 911, along with the particular assigned event 930, will be presented in one or more user interfaces for a particular event 200.

The system can also be adapted to generate, train, and execute a plurality of trained learning models, nodes, neural networks, gradient boosting algorithms, mutual information classifiers, random forest classifications, and other machine learning and artificial intelligence related algorithms to process the parameters, features, and other data elements. In some embodiments, the one or more trained learning models can include deep learning, machine learning, neural networks, computer vision and similar advanced artificial intelligence-based technologies. When used throughout the present disclosure, one skilled in the art will understand that processes for iteratively training the “trained learning model” can include machine learning processes and other advanced artificial intelligence processes. For example, the system and processes of the present disclosure can perform data processing, image analysis, generate tasks or action items, provide customized recommendations according to user settings and preferences, generate interfaces, generate reports, generate files, generate notifications, and similar processes. In some embodiments, the system may use additional inputs and/or feedback loops to an iterative training process for a personalized event hosting process based on a plurality of parameters and adjustable metric values.

In one non-limiting example, the advanced platform system and method can utilize a trained learning model to extract information about one or more available items and automatically assign the one or more available items to either a physical lane or a virtual lane. The trained learning model can also be trained to extract information from one or more images of an available item and automatically populate information associated with the available item (including, but not limited to, the information 211 shown in FIG. 2). In some embodiments, the trained learning model can reassign, reorder, or otherwise update the configuration of the available items on the one more interfaces described herein, based on the output of the trained learning model. The trained learning model can further be adapted to provide recommended event selections, lane assignments, remuneration values, available item orders, descriptions, and other features. The user can review the recommendations and select whether to approve or deny the recommendation, which can be used to generate a command to the system to update the user interface(s) and generate and updated display accordingly based on the user selection.

In at least this way, the present teachings provide an advanced platform system to address shortcomings found in existing systems, namely (1) processing information associated with physical and virtual events consistently to provide a uniform user experience for an operator hosting an event with physical and virtual transfers, and (2) processing information associated with physical and virtual available items consistently to provide a uniform user experience for a participant providing submissions for the event.

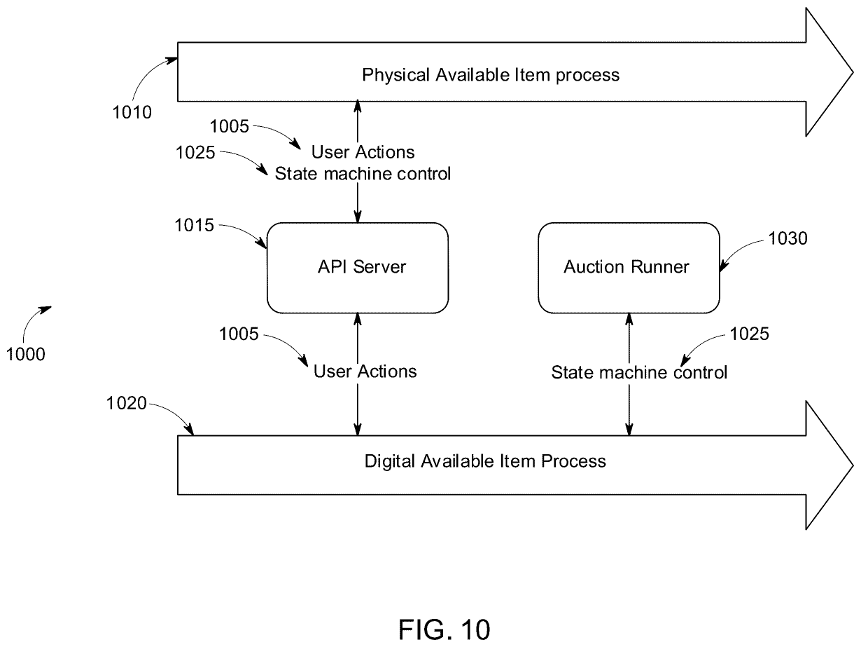

Referring now to FIG. 10, shown is an example method of operation 1000 for the system of FIG. 1. FIG. 10 shows the controlling systems involved in running an event, specifically in processing one or more available items in a lane. The controlling system determines whether the available item of the one or more available items is a physical available item or a virtual available item, in some embodiments with the process described in connection with FIG. 9. Depending on the format of the available item (e.g., physical or virtual), the available item is routed through the physical available item process 1010 or the virtual available item process 1020. Although the processes 1010 and 1020 are different, the user experience hosting the event and participating in the event is consistent.

The physical available item process 1010 is controlled by user interactions 1005 and state machine control 1025 through the Application Programming Interface (API) Server 1015, wherein the user interactions can include the event host and/or the event participants. The state machine control 1025 can include one or more conditions or other control parameters. In some forms, the state machine control 1025 can include one or more automation aspects. The event host and/or operator controls the flow of the event through user interactions 1005 that dictate the opening and closing of submissions and the procession of available items through the lane(s), according the state machine control(s). On the other hand, the virtual available item process 1020 utilizes a combination of user interactions 1005 through the API Server 1015 and automation provided by the event runner system 1030. In some embodiments, the automation can include the state machine control 1025. The event runner can act autonomously based off a system of timed tasks that control the current available item on the block, opening submissions and ending submissions once the allotted time for that available item has elapsed. It will be appreciated that other arrangements and configurations are contemplated.

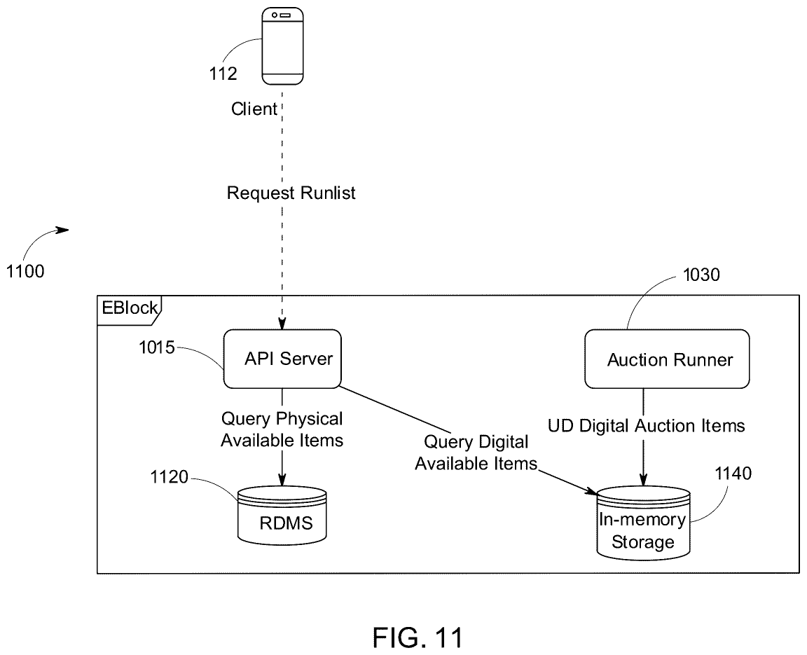

Referring now to FIG. 11, shown is an example workflow 1100 for the system of FIG. 1. A computing device 112 may request a runlist from an API server 1015. The API server 1015 may query a relational database management system (RDMS) 1120 where the available item is related to a physical lane 203. The event operator or other user may provide information relating to items in the physical lane 203 to the RDMS 1120. The API server 1015 may query an in-memory storage 1140 where the available item is related to a virtual lane 202. The event runner 1030 may provide information relating to available items in a virtual lane 202 to the in-memory storage 1140. In response to receiving the runlist request from the computing device 112, the advanced platform system can generate and transmit a runlist including the available items at the event, including both the physical available items and the virtual available items.

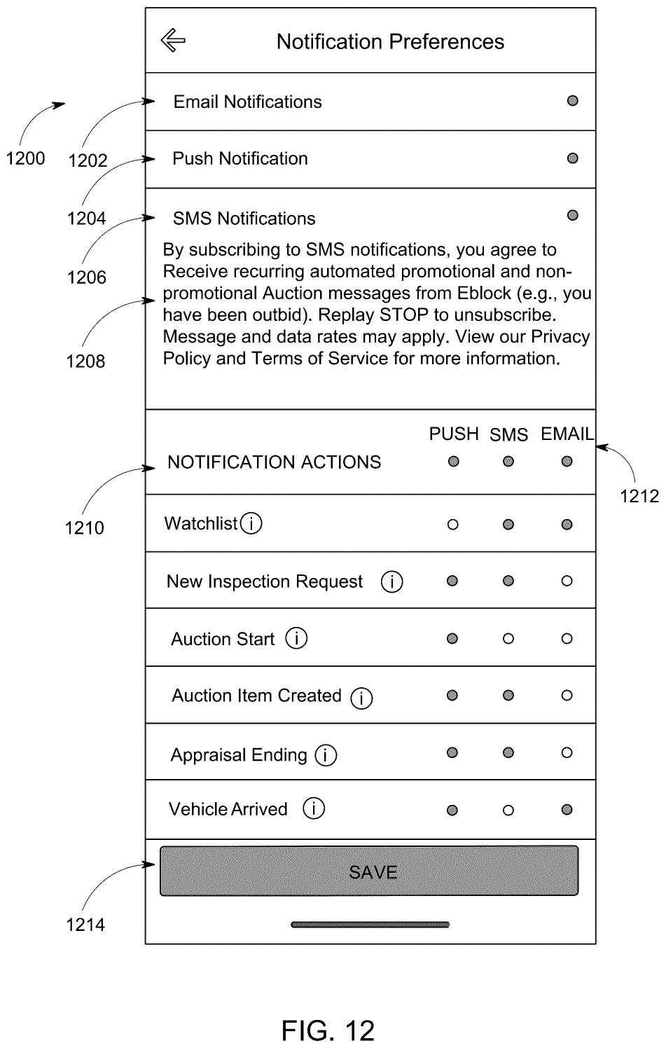

Referring now to FIG. 12, shown is an example user interface 110 provided in the form of a notification interface 1200. The notification interface 1200 may be visible to a user interested and/or participating in an event. The notification interface 1200 provides a uniform notification platform for virtual and physical events. A user may select a number of notification preferences using the notification interface 1200, where the notification(s) can be provided in the form of email notifications 1202, push notifications 1204, SMS notifications 1206, or a combination thereof. The notification interface 1200 can also be adapted to generate information 1208 relating to the notifications (e.g., a notification relating to charges for data transfer over SMS).

A user may also select notification actions 1210 relating to the user's preference for the type of notifications received, including one or more of available items on the user's watchlist, a new inspection request, an event start time or date, available items created by or submitted by an operator or event host, evaluation periods for available items ending or beginning and the results of the evaluation, arrival of an available item to the event platform, and items having sold. In the embodiment shown, a user may further select independent notification method preferences 1212 for each notification action 1210. The notification interface 1200 can also include a Save button 1214 for saving user selections. It will be appreciated that other arrangements and configurations of the notification interface 1200 are contemplated.

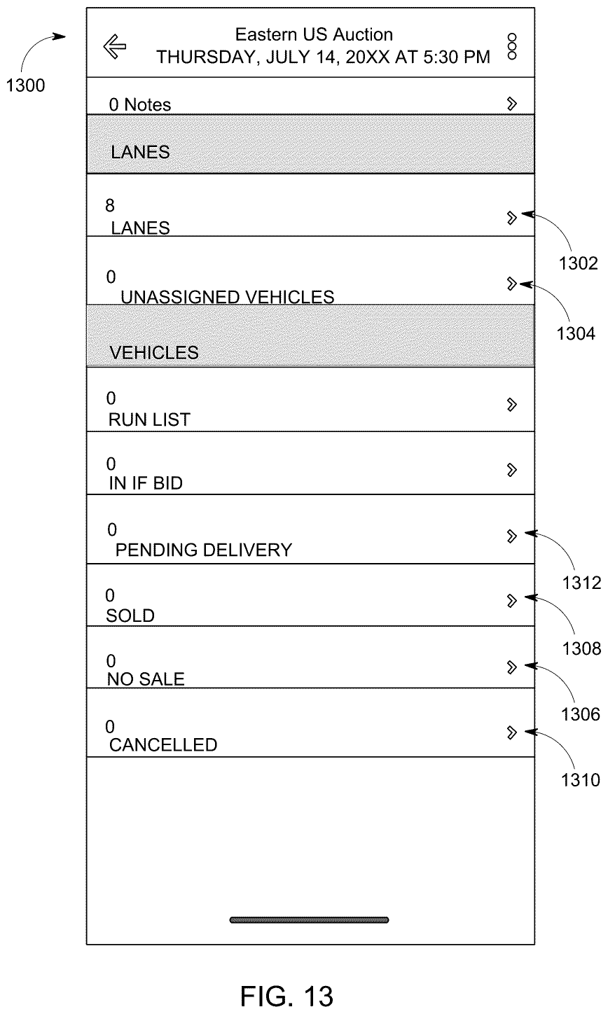

Referring now to FIG. 13, shown is an example user interface 110 provided in the form of an event information interface 1300 for a particular event 200 that may have been selected by a user independently or through another user interface 110 discussed herein. In general, the event information interface 1300 may be tailored for use by the operator to include information about the event. For example, the user interface 110 may include information regarding the number of active lanes 1302 in the event 200, the remaining available items which have not yet been assigned 1302 to a particular physical lane 203 or virtual lane 202, the number of available items which have not been transferred 1306 or have been transferred 1308, the number of available items which have been canceled 1310 or removed from the event 200, the number of available items which must be delivered 1312 to users with winning submissions, and other such information discussed herein and known in the art. A user or operator may further select any of the aforementioned categories (or other selections, not shown) to explore other user interfaces 110 related to the selection, such as shown for example in FIG. 8 or FIG. 15, allowing additional specifics related to the selection to be shown.

A system according to the present teachings provides a single event hosting platform for virtual and physical events, which also provide a uniform user interface experience for participants.

Previous technologies required a user or operator to pick one of a virtual event or a physical event to attend or monitor, reducing a user's or operators access to potential available items and/or participants. The present teachings provide an integrated experience providing a user with the choice of attending events in person and/or virtually using an advanced platform that provides a uniform experience without missing out on potential available items or items of interest.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for virtual and physical events involving multiple users, comprising:
a computer system in communication with a datastore;
a plurality of events stored in the datastore, each event having a plurality of transfers, the plurality of transfers including a physical transfer and a virtual transfer;
each of the plurality of transfers having a plurality of available items;
the computer system adapted to provide a user interface to a computing device, the user interface showing a lane for each of the plurality of available items, such that a physical lane associated with a physical available item in the physical transfer and a virtual lane associated with a virtual available item in the virtual transfer can be generated simultaneously on the user interface; and
the computer system adapted to receive a submission through the user interface on the computing device for one of the plurality of available items.

2. The system of claim 1, wherein the user interface provides the same submission controls for either a physical available item or a virtual available item to provide a user a consistent experience, wherein a submission includes a bid for one of the plurality of available items.

3. The system of claim 1, further comprising:
the computer system adapted to provide an operator interface for configuring the plurality of events, the plurality of transfers associated with each event, the plurality of available items associated with each transfer, and a lane for each of the plurality of available items; and
such that the operator interface provides the same configuration controls for configuring either the physical available item or the virtual available item so that a user has a consistent experience.

4. The system of claim 3, wherein available items can be configured to move between the physical lane and the virtual lane.

5. The system of claim 1, further comprising notifications that include both physical available items and virtual available items.

6. The system of claim 1, wherein the user interface comprises a webpage.

7. The system of claim 1, wherein the computer system comprises processors communicating with each other over a network.

8. The system of claim 1, wherein the user interface comprises a selection of available events, and when a selected event is selected the user interface display a plurality of lanes for the selected event horizontally, and each of the associated plurality of available items for each lane are generated horizontally below the plurality of lanes.

9. The system of claim 1, further comprising:
the computer system adapted to provide remuneration information using a trained learning model, wherein the trained learning model is trained using starting remuneration, updated remuneration throughout the event, remuneration of similar items from past events, condition of the one of the plurality of available items, or a combination thereof.

10. A system for hosting events with multiple users, comprising:
a computer system in communication with a datastore;
a plurality of events stored in the datastore, including virtual events and physical events;
each of the plurality of events having a plurality of available items, including virtual items and physical items;
the computer system adapted to provide an operator interface to a computing device, the operator interface showing a lane for each of the plurality of available items;
such that a physical available item can be assigned to a physical lane and a virtual available item can be assigned to a virtual lane; and
the computer system adapted to receive a selection through the operator interface on the computing device for adjusting an assignment for one of the plurality of available items and adjust the assignment for the one of the plurality of availability items based on the selection.

11. The system of claim 10, wherein the operator interface can be accessed via a mobile application, a webpage, or a combination thereof.

12. The system of claim 10, wherein the operator interface can include a lane identification for the lane for each of the plurality of available items.

13. The system of claim 10, wherein the operator interface can include an assigned number of the plurality of available items assigned to the lane.

14. The system of claim 10, wherein the computer system comprises processors communicating with each other over a network.

15. The system of claim 10, further comprising:
a submission interface of the operator interface, wherein the computer system is adapted to receive user inputs associated with each of the plurality of available items.

16. The system of claim 15, wherein the user inputs can include an image, remuneration information, a location, an assigned lane, a declaration, a report, or a combination thereof.

17. The system of claim 16, wherein the user inputs are provided by an output of a trained learning model.

18. The system of claim 10, wherein the computer system is further adapted to:
extract information associated with the plurality of available items from the datastore;
parse the information associated with the plurality of available items;
identify a particular format of the plurality of available items, wherein the particular format includes a virtual format or a physical format based on whether the available item is a virtual available item or a physical available item;
assign each of the plurality of available items to one of the plurality of events;
assign each of the plurality of available items to a particular lane based on the particular format identified for the plurality of available items;
generate a lane identification and an assigned number on the operator interface for each of the plurality of available items; and
receive user inputs via a submission interface, wherein the user inputs are associated with one or more of the plurality of available items.

19. A method for hosting physical and virtual events with one or more participants, comprising:
providing information related to a plurality of available items, including physical available items or virtual available items;
providing a computer system adapted to process the information related to the plurality of available items for one or more events;
identifying one or more parameters associated with the plurality of available items using the computing system, including whether an available item is a physical item or a virtual item;
assigning the plurality of available items to a plurality of lane of the one or more events, including either a physical lane or a virtual lane based on whether the available item is the physical item or the virtual item;
generating an operator interface to a computing device, the operator interface showing a lane for each of the plurality of available items;
receiving a selection through the operator interface using the computer system, wherein the selection includes adjusting an assignment for one of the plurality of available items; and
adjusting the assignment for the one of the plurality of availability items based on the selection.

20. The method for hosting physical and virtual events of claim 19, further comprising:
receiving one or more submissions from the one or more participants using a submission interface of the computing system;
processing the one or more submissions;
determining which submission is a higher value submission;
generating a notification to a participant associated with the higher value submission using a notification interface of the computing system; and
transmitting the notification to a computing device associated with the participant associated with the higher value submission.
